(19) United States
(12) Patent Application Publication
(10) Pub. No.: US 2016/0066548 A1
(43) Pub. Date: Mar. 10, 2016

(54) BIRD FEEDER

(71) Applicant: DAVID L. HARRIS, WEEMS, VA (US)

(72) Inventor: DAVID L. HARRIS, WEEMS, VA (US)

(21) Appl. No.: 14/847,587

(22) Filed: Sep. 8, 2015

Related U.S. Application Data
(60) Provisional application No. 62/070,818, filed on Sep. 8, 2014.

(51) Int. Cl. A01K 39/014

(52) U.S. Cl. CPC A01K 39/014

(57) ABSTRACT

A bird feeder comprising a main body having an open top end and an open bottom end, a lid selectively removably affixed to the top end of the main body, a base affixed to the bottom end of the main body, and one or more hanging bird food receptacles suspended from the lid and selectively removable from the main body when the lid is selectively removed from the top end of the main body. The main body, the lid, and the base together form an enclosure when the lid is selectively affixed to the top end of the main body.

### CROSS-REFERENCE TO RELATED APPLICATIONS

This application claims priority to U.S. Provisional Application Ser. No. 62/070,818, filed Sep. 8, 2014, the contents of which are incorporated herein by reference in its entirety.

### FIELD OF THE INVENTION

The present disclosure relates generally to bird feeders.

### BACKGROUND OF THE DISCLOSURE

It is well known that squirrels interfere with the intended function of bird feeding devices by way of removal of the food intended for birds and physical destruction of the feeding device. Devices earlier proposed for eliminating the problems caused by squirrels have either been expensive, ineffective, or adversely affected by weather factors. Also, by virtue of specialized structure, earlier squirrel resistant bird feeders have not been able to hold both bird seed and suet feed.

### BRIEF SUMMARY OF THE DISCLOSURE

In one embodiment of the invention, a bird feeder comprises a main body having an open top end and an open bottom end, a lid selectively removably affixed to the top end of the main body, a base affixed to the bottom end of the main body, and one or more hanging bird food receptacles suspended from the lid and selectively removable from the main body when the lid is selectively removed from the top end of the main body. The main body, the lid, and the base together form an enclosure when the lid is selectively affixed to the top end of the main body.

The one or more hanging bird food receptacles may comprise a first hanging bird food receptacle and a second hanging bird food receptacle suspended directly below the first hanging bird food receptacle. The one or more hanging bird food receptacles may be suspended from the lid via a rigid support staff rigidly affixed to the lid. The bird feeder may further comprise a hanging hook affixed to the lid.

Each of the one or more hanging bird food receptacles may comprise a square, rectangular, or round tray having a bottom surface, one or more side walls, and an open top end. Each of the one or more hanging bird food receptacles may be constructed of a solid material or a mesh material.

One or more drainage holes may be defined in the one or more hanging bird food receptacles, the drainage holes sized to allow water to drain from the one or more hanging bird food receptacles while containing one or more types of bird food.

The main body, the lid, and the base may be constructed of wire mesh. The lid may be constructed at least partly of a sold, rain-deflecting material. The enclosure may have a rectangular parallelepiped or cylindrical shape.

The base may be hingedly affixed to the bottom end of the main body and selectively movable between a closed position and an open position. A bottom bird food receptacle may be affixed to a top surface of the base such that the bottom bird food receptacle moves with the base when the base selectively moves between the open position and the closed position.

The bottom bird food receptacle may comprise one or more protrusions upwardly projecting from an interior bottom surface of the bottom food receptacle for securing suet therein.

The bottom bird food receptacle may comprise a square, rectangular, or round tray having a bottom surface, one or more side walls, and an open top end. The bottom bird food receptacle may be constructed of a solid material or a mesh material. One or more drainage holes may be defined in the bottom bird food receptacle, the drainage holes sized to allow water to drain from the bottom bird food receptacle while containing one or more types of bird food.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a front view of a bird feeder, in a closed configuration, in accordance with embodiments of the invention.

FIG. 2 is a partial front view of the device of FIG. 1, with the base in an open configuration.

FIG. 3 is a front view of the lid and two of the feeding compartments of the device of FIG. 1, removed from the device.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the present invention provide a bird feeder that protectively and separately houses more than one variety of bird food. In one exemplary embodiment, the bird feeder houses suet (or the like) and one or more kinds of bird seed in separate receptacles. The bird feeder of embodiments of the invention preferably, although not necessarily, prevents squirrels (and possibly large birds) from obtaining the bird food.

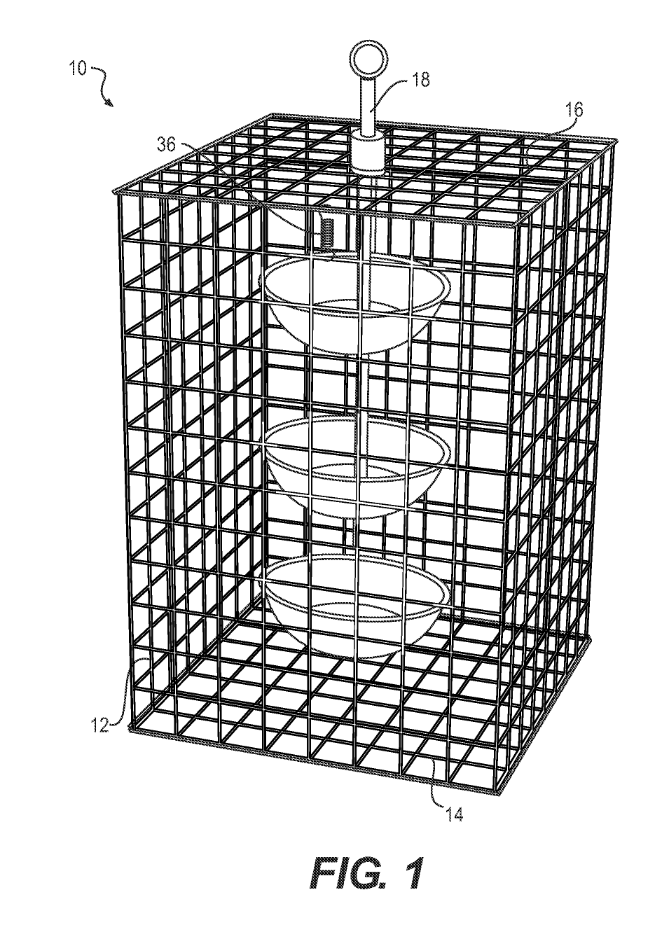

Referring now to FIGS. 1-3, a bird feeder 10 is illustrated in accordance with embodiments of the invention. The bird feeder 10 comprises a main body 12 having an open top end and an open bottom end, a lid 16 selectively removably affixed to the top end of the main body 12, and a base 14 affixed to the bottom end of the main body. The main body, the lid, and the base together form an enclosure when the lid is selectively affixed to the top end of the main body.

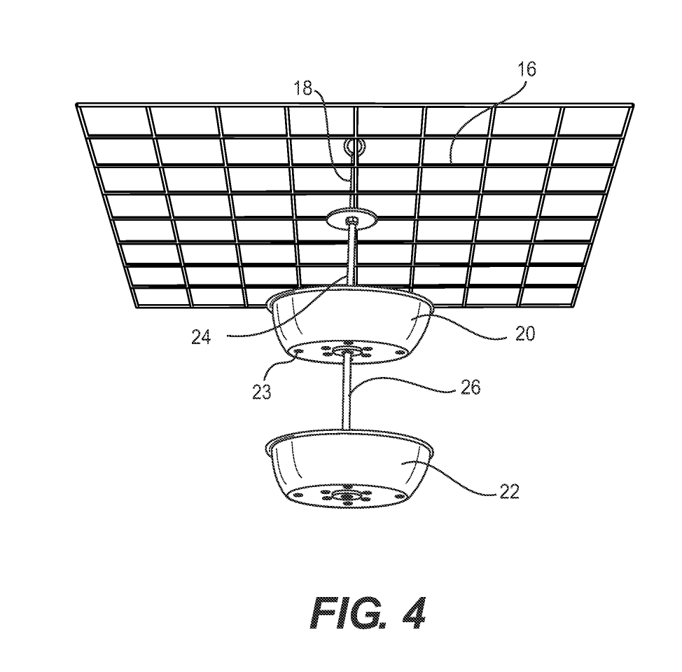

Advantageously, one or more hanging bird food receptacles (two are illustrated) 20, 22 (labeled only in FIG. 3 for clarity) are suspended from the lid 16. The hanging bird food receptacles are typically (but not necessarily) suspended from the center of the lid. Different types of bird food may be placed in each of the hanging bird food receptacles if desired. The hanging bird food receptacles are within the enclosure when the lid is in place on the main body, and therefore the bird food contained therein is protected. Because the lid 16 is selectively removably affixed to the main body 12, the hanging bird food receptacles are selectively removable from the main body 12 when the lid 16 is selectively removed. The lid and hanging bird food receptacles may be removed from the main body for cleaning or filling of the hanging bird food receptacles. Although the hanging bird food receptacles may also be filled while in place in the enclosure by use of a long, narrow funnel, the ability to remove the hanging bird food receptacles from the main body enables the hanging bird food receptacles to be filled with bird food that cannot be conveyed by a funnel, such as suet, peanut butter, etc.

As illustrated, the hanging bird food receptacles may be suspended one directly beneath the other. The hanging bird food receptacles may be suspended from the lid using any suitable mechanism. For example, the hanging bird food receptacles may be suspended from the lid via a rigid support staff rigidly affixed to the lid. FIG. 3 illustrates the use of a first support staff 24 to support the upper hanging receptacle 20 from the lid 16 and a second support staff 26 to support the lower hanging receptacle 22 from the upper hanging receptacle 20. Alternatively, a single unitary support staff may extend from the lid, through the upper hanging receptacle all the way down to the lower hanging receptacle. Any suitable mechanism may be used to affix the support staff(s) to the lid and to the hanging bird food receptacles. For example, the support rods may have male threaded ends that engage female threads on the hanging bird food receptacles or that protrude through the bottom surfaces of the hanging bird food receptacles and engage threaded nuts.

The hanging bird food receptacles may comprise square, rectangular, or round trays (only round trays are illustrated) that have a bottom surface, one or more side walls, and an open top end, as illustrated. The hanging bird food receptacles may be constructed of any suitable material, such as metal or plastic. The hanging bird food receptacles may be constructed of a solid material (as illustrated) or a mesh material (if a mesh material is used, the mesh material may be selected to have openings sized to allow water to drain while containing one or more types of bird seed; larger openings may be used if the hanging food receptacles are intended to only hold suet cakes and the like). One or more drainage holes 23 may be defined in the one or more hanging bird food receptacles 20, 22. The drainage holes are typically sized to allow water to drain while containing one or more types of bird food.

When the lid 16 is to be selectively affixed to the top end of the main body 12, the lid 16 may be secured to the main body 12 using any suitable mechanism that is both secure and easily affixed and detached. In the illustrated embodiment, two or more extension springs 36 may be used (only one is illustrated for clarity), typically on opposing sides of the lid and main body. Each extension spring would typically have one end secured to one side of the main body and an opposite end secured to the lid. Typically, one end of the extension spring would have a relatively large open loop to enable that end to be readily selectively affixed and detached to/from the lid or main body, while the other end would be more securely affixed to the main body or lid, respectively.

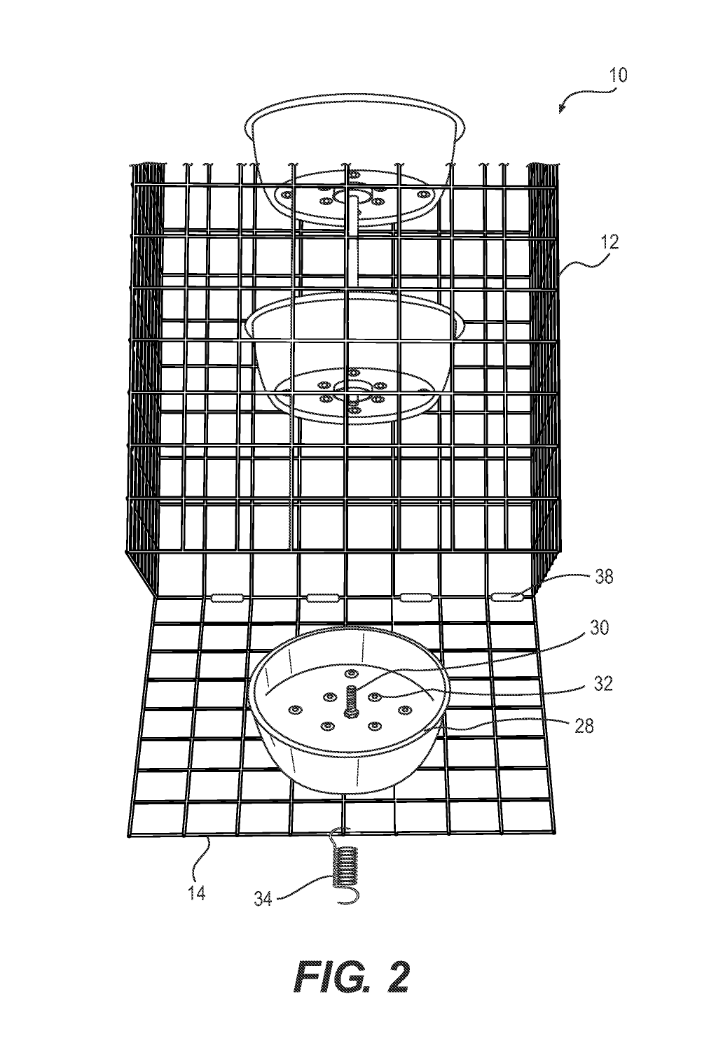

Advantageously, the base 14 may be hingedly affixed to the bottom end of the main body 12 via one or more hinges 38. This allows the base 14 to be selectively movable between a closed position (illustrated in FIG. 1) and an open position (illustrated in FIG. 2). A bottom bird food receptacle 28 is affixed to a top surface of the base 14. The bottom bird food receptacle is typically (but not necessarily) affixed to the center of the top surface of the base. As such, the bottom bird food receptacle 28 moves with the base when the base is selectively moved between the open position and the closed position. The open position enables the bottom bird food receptacle 28 to be readily cleaned and filled. Although the bottom bird food receptacle may also be filled while the base is closed by use of a long, narrow funnel, the ability to open the base improves access to the bottom bird food receptacle and more readily enables the bottom bird food receptacle to be filled with bird food that cannot be conveyed by a funnel, such as suet, peanut butter, etc.

The base may be held closed using any suitable mechanism that is both secure and easily affixed and detached. In the illustrated embodiment, one or more extension springs 34 may be used (one is illustrated), typically on the end of the base opposite the hinges. The extension spring would typically have one end secured to the end of the base and an opposite end secured to the main body. Typically, one end of the extension spring would have a relatively large open loop to enable that end to be readily selectively affixed and detached to/from the base or main body, while the other end would be more securely affixed to the main body or base, respectively.

The bottom bird food receptacle 28 may comprise one or more protrusions 30 (one is illustrated) projecting upward from the interior bottom surface of the bottom food receptacle. A suet cake or other similar bird food may be pushed down onto such a protrusion, to enable the suet cake to be securely retained in the bottom bird food receptacle 28.

The bottom bird food receptacle may comprise a square, rectangular, or round tray (a round tray is illustrated) that has a bottom surface, one or more side walls, and an open top end, as illustrated. The bottom bird food receptacle may be constructed of any suitable material, such as metal or plastic. The bottom bird food receptacle may be constructed of a solid material (as illustrated) or a mesh material (if a mesh material is used, the mesh material may be selected to have openings sized to allow water to drain while containing one or more types of bird seed; larger openings may be used if the bottom food receptacle is intended to only hold suet cakes and the like). One or more drainage holes 32 may be defined in the bottom bird food receptacle. The drainage holes are typically sized to allow water to drain while containing one or more types of bird food.

The bird feeder 10 may further comprise a hanging hook 18 affixed to the lid, or any other suitable hanging mechanism. The hanging mechanism may be attached to the lid, as illustrated, or alternatively to the main body.

The main body 12, the lid 16, and the base 14 may be constructed of mesh (typically wire or metal mesh, although any other suitable material may be used). The openings in the wire mesh are typically sized to allow smaller birds to enter the enclosure while keeping out larger birds and squirrels. The openings in the wire mesh of the main body, the lid, and the base may all be the same size, or may be different sizes. In one embodiment of the invention, the openings (at least of the main body) are 1.5 inches square. The openings in the lid and/or base may be the same or different than the openings of the main body. In one embodiment of the invention, the openings of the lid and base are 0.5 inches square.

The lid 16 may be constructed at least partly of a sold, rain-deflecting material (not illustrated), or may have a sold, rain-deflecting material attached thereto (not illustrated). The enclosure may have a rectangular parallelepiped shape (as illustrated), a cylindrical shape (not illustrated), or any other suitable shape.

The bird feeder may be any suitable size. In one embodiment of the invention, the bird feeder is 18 inches tall, 12 inches wide, and 12 inches deep.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A bird feeder comprising:
a main body having an open top end and an open bottom end;
a lid selectively removably affixed to the top end of the main body;
a base affixed to the bottom end of the main body; and
one or more hanging bird food receptacles suspended from the lid and selectively removable from the main body when the lid is selectively removed from the top end of the main body;
wherein the main body, the lid, and the base together form an enclosure when the lid is selectively affixed to the top end of the main body.

2. The bird feeder of claim 1, wherein the one or more hanging bird food receptacles comprise a first hanging bird food receptacle and a second hanging bird food receptacle suspended directly below the first hanging bird food receptacle.

3. The bird feeder of claim 1, wherein the one or more hanging bird food receptacles are suspended from the lid via a rigid support staff rigidly affixed to the lid.

4. The bird feeder of claim 1, further comprising a hanging hook affixed to the lid.

5. The bird feeder of claim 1, wherein each of the one or more hanging bird food receptacles comprise a square, rectangular, or round tray having a bottom surface, one or more side walls, and an open top end.

6. The bird feeder of claim 1, wherein each of the one or more hanging bird food receptacles are constructed of a solid material or a mesh material.

7. The bird feeder of claim 1, wherein one or more drainage holes are defined in the one or more hanging bird food receptacles, the drainage holes sized to allow water to drain from the one or more hanging bird food receptacles while containing one or more types of bird food.

8. The bird feeder of claim 1, wherein the main body, the lid, and the base are constructed of wire mesh.

9. The bird feeder of claim 1, wherein the lid is constructed at least partly of a sold, rain-deflecting material.

10. The bird feeder of claim 1, wherein the enclosure has a rectangular parallelepiped or cylindrical shape.

11. The bird feeder of claim 1, wherein the base is hingedly affixed to the bottom end of the main body and selectively movable between a closed position and an open position; and
wherein a bottom bird food receptacle is affixed to a top surface of the base such that the bottom bird food receptacle moves with the base when the base selectively moves between the open position and the closed position.

12. The bird feeder of claim 11, wherein the bottom bird food receptacle comprises one or more protrusions upwardly projecting from an interior bottom surface of the bottom food receptacle for securing suet therein.

13. The bird feeder of claim 11, wherein the bottom bird food receptacle comprises a square, rectangular, or round tray having a bottom surface, one or more side walls, and an open top end.

14. The bird feeder of claim 11, wherein the bottom bird food receptacle is constructed of a solid material or a mesh material.

15. The bird feeder of claim 11, wherein one or more drainage holes are defined in the bottom bird food receptacle, the drainage holes sized to allow water to drain from the bottom bird food receptacle while containing one or more types of bird food.
